(19) United States
(12) Patent Application Publication
(10) Pub. No.: US 2007/0226445 A1
(43) Pub. Date: Sep. 27, 2007

(54) Method and system for rapid data-fragmentation analysis of a file-allocation-table (FAT) file system

(76) Inventors: Tony Nichols, Erie, CO (US); Paul Para, Boulder, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/386,375

(22) Filed: Mar. 22, 2006

(51) Int. Cl. G06F 12/00

(52) U.S. Cl. 711/170

(57) ABSTRACT

A method and system for rapid data-fragmentation analysis of a file-allocation-table (FAT) file system is described. One illustrative embodiment reads into a memory of a computer a FAT associated with a storage medium of the computer, the storage medium having a plurality of clusters, each cluster having an associated entry in the FAT; and analyzes, substantially without accessing a directory table associated with the storage medium, the FAT to estimate the extent of data fragmentation on the storage medium.

### RELATED APPLICATIONS

The present application is related to the following commonly owned and assigned applications: U.S. application Ser. No. (unassigned), Attorney Docket No. WEBR-040/00US, “Method and System for Rapid Data-Fragmentation Analysis of a New Technology File System (NTFS),” filed herewith; and U.S. application Ser. No. 11/145,593, Attorney Docket No. WEBR-009/00US, “System and Method for Neutralizing Locked Pestware Files,” which is incorporated herein by reference in its entirety.

### FIELD OF THE INVENTION

The present invention relates to computer storage technology. In particular, but without limitation, the present invention relates to methods and systems for evaluating the extent of data fragmentation on a computer storage medium.

### BACKGROUND OF THE INVENTION

A number of variables influence computer performance. Factors such as processor speed, the size and speed of random-access memory (RAM), the speed of the system's internal bus, and the speed of disk access all play a role. The speed of disk access is particularly important since disk drives are slower than RAM, and many computer applications involve extensive disk access.

A formatted computer storage medium (e.g., a hard disk) typically contains data storage units called “clusters,” each of which is usually a power-of-two multiple of a smaller 512-byte-long unit called a “sector”; directory or index information about the files and folders stored on the storage medium; and a system for keeping track of which clusters are in use and to which file or folder each cluster belongs. Two well-known file-system architectures are the file-allocation-table (FAT) file system and the New Technology File System (NTFS). These two architectures take very different approaches to organizing and keeping track of data on a storage medium.

The longer a storage medium is used, the more fragmented the data on the storage medium become. That is, the clusters associated with an increasing number of files on the storage medium are scattered rather than contiguous. On a disk drive, reading a fragmented file requires more time than reading a non-fragmented file because the drive head has to jump around on the storage medium to access the scattered clusters making up the file. This extra “seek time” degrades system performance. Since flash-memory-based storage media such as secure digital (SD) cards and multi-media cards (MMCs) are typically formatted like disk volumes, fragmentation can also slow down the reading of data from those storage media, although the problem of seek time that occurs with disk drives is absent.

Utilities for defragmenting a storage medium have become commonplace. Such utilities rewrite the data on the storage medium, rendering contiguous the clusters making up each file. Before a computer user incurs the time and possible risk to data involved in using a defragmentation utility, however, the user may wish to test the storage medium first to measure the extent of data fragmentation. Conventional methods for evaluating the extent of fragmentation on a storage medium employing a FAT file system involve accessing the storage medium's directory tables repeatedly to identify one file at a time, locating the FAT entry for the first cluster of each file, and tracing the subsequent FAT entries associated with that file to determine whether the file contains any fragmentations. These conventional methods can require a significant amount of time to execute (e.g., several minutes), especially for large storage media.

It is thus apparent that there is a need in the art for an improved method and system for rapid data-fragmentation analysis of a FAT file system.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a method and system for rapid data-fragmentation analysis of a file-allocation-table (FAT) file system. One illustrative embodiment of the invention is a method comprising reading into a memory of a computer a FAT associated with a storage medium of the computer, the storage medium having a plurality of clusters, each cluster having an associated entry in the FAT; and analyzing, substantially without accessing a directory table associated with the storage medium, the FAT to estimate the extent of data fragmentation on the storage medium.

Another illustrative embodiment is a system comprising a data acquisition module configured to read into a memory of a computer a FAT associated with a storage medium of the computer, the storage medium having a plurality of clusters, each cluster having an associated entry in the FAT; and an analysis module configured to analyze, substantially without accessing a directory table associated with the storage medium, the FAT to estimate the extent of data fragmentation on the storage medium.

Another illustrative embodiment is a computer-readable storage medium comprising a first instruction segment configured to read into a memory of a computer a file allocation table (FAT) associated with a storage medium of the computer, the storage medium having a plurality of clusters, each cluster having an associated entry in the FAT; and a second instruction segment configured to analyze, substantially without accessing a directory table associated with the storage medium, the FAT to estimate the extent of data fragmentation on the storage medium. These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a high-level functional block diagram of a computer equipped with a fragmentation analysis system, in accordance with an illustrative embodiment of the invention;

FIG. 2A is a diagram of a non-fragmented file and its associated file-allocation-table (FAT) entries, in accordance with an illustrative embodiment of the invention;

FIG. 2B is a diagram of a fragmented file and its associated FAT entries, in accordance with an illustrative embodiment of the invention;

FIG. 3 is a diagram of a FAT used in explaining how the extent of data fragmentation on a storage medium can be estimated substantially without accessing a directory table of the storage medium, in accordance with an illustrative embodiment of the invention;

FIG. 4 is a flowchart of a method for estimating the extent of data fragmentation on a storage medium, in accordance with an illustrative embodiment of the invention; and

FIGS. 5A-5C are a flowchart of a method for estimating the extent of data fragmentation on a storage medium, in accordance with another illustrative embodiment of the invention.

### DETAILED DESCRIPTION

Determining the extent of data fragmentation (“fragmentation analysis”) on a storage medium formatted with a file-allocation-table (FAT) file system can be sped up significantly by reading the FAT into the computer's random-access memory (RAM) and, substantially without accessing any directory tables of the storage medium, analyzing the FAT. Where all that is needed is a reasonably accurate estimate of the extent of data fragmentation to aid a user in deciding whether to defragment the storage medium, it is unnecessary to identify files and folders as such using the directory tables and to trace their associated FAT entries. Instead, FAT entries can be examined quickly and efficiently in sequential order, and a variety of statistics can be compiled to evaluate the extent of data fragmentation on the storage medium. The results may be reported to a user, and a recommendation may be made that the storage medium be defragmented, if the extent of data fragmentation exceeds a predetermined threshold.

A count of clusters associated with fragmented files (“fragmented clusters”), clusters associated with non-fragmented files (“non-fragmented clusters”), used clusters, unused clusters, and files (including folders or directories) can be gathered by examining FAT entries in sequential order in RAM without consulting directory tables of the storage medium. To improve the accuracy of the fragmentation estimate, the structure of individual files on the storage medium can also be inferred from the FAT entries. For example, where it is inferred that a particular group of clusters constitute a file having at least one “fragmentation,” all clusters in that particular group of clusters can be treated as “fragmented” and can be included in a count of “fragmented clusters.” Herein, a “fragmentation” is an interruption in the contiguity on a storage medium of the clusters making up a file or folder. In one illustrative embodiment, the ratio of fragmented clusters to total used clusters on the storage medium is computed and used to determine whether defragmentation of the storage medium is advisable.

In some embodiments, the FAT is read into RAM in its entirety before the fragmentation analysis begins. In other embodiments, only a portion of the FAT is read into RAM initially, and other portions are fetched from the storage medium as needed. In one illustrative embodiment, directory tables associated with the storage medium are not accessed at all in connection with the fragmentation analysis. In other embodiments, a limited amount directory-table access may be part of the fragmentation analysis.

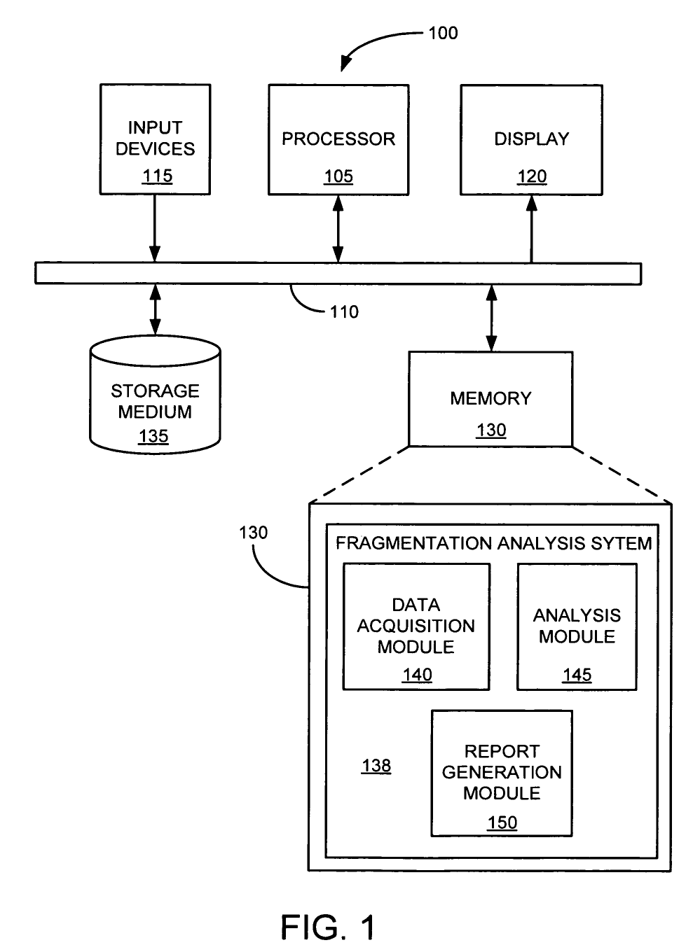

Referring now to the drawings, where like or similar elements are designated with identical reference numerals throughout the several views, FIG. 1 is a high-level block diagram of a computer 100 equipped with a fragmentation analysis system, in accordance with an illustrative embodiment of the invention. Computer 100 may be a desktop computer, workstation, laptop computer, notebook computer, handheld computer, or any other device that includes computing functionality. In FIG. 1, processor 105 communicates over data bus 110 with input devices 115, display 120, memory 130, and storage medium 135.

Input devices 115 may be, for example, a keyboard and a mouse or other pointing device. In an illustrative embodiment, storage medium 135 is a disk volume such as a hard disk drive (HDD). In other embodiments, however, storage medium 135 may be any rewritable storage medium having a FAT file system, including, without limitation, magnetic disks, rewritable optical discs, and flash-memory-based storage media such as secure digital (SD) cards and multi-media cards (MMCs). Memory 130 may include random-access memory (RAM), read-only memory (ROM), or a combination thereof.

Fragmentation analysis system 138 estimates the extent of data fragmentation on storage medium 135. In some embodiments, the estimate is highly accurate. In other embodiments, the estimate may be designed to be less accurate, depending on the application. In the illustrative embodiment of FIG. 1, fragmentation analysis system 138 is an application program stored on a computer-readable storage medium of computer 100 (e.g., storage medium 135) that can be loaded into memory 130 and executed by processor 105. In other embodiments, the functionality of fragmentation analysis system 138 can be implemented in software, firmware, hardware, or any combination thereof.

For convenience in this Detailed Description, the functionality of fragmentation analysis system 138 has been subdivided into three modules: data acquisition module 140, analysis module 145, and report generation module 150. In various embodiments of the invention, the functionality of these three modules may be combined or subdivided in a variety of ways different from that shown in FIG. 1. Data acquisition module 140 is configured to read a FAT associated with storage medium 135 into RAM (memory 130). Analysis module 145 is configured to analyze the FAT to estimate the extent of data fragmentation on storage medium 135. Optional report generation module 150 is configured to report the results of the fragmentation analysis to a user and, where applicable, to recommend defragmentation.

As mentioned above, fragmentation analysis system 138 performs its functions substantially without accessing any directory tables associated with storage medium 135. In FAT file systems, a directory table is a special type of file that contains metadata about the files and other directories (or “folders”) stored within a particular directory/folder. Each entry in the directory table contains the name, extension, and other information associated with the corresponding file or folder, including the address of the first cluster of the file or folder on storage medium 135. In one illustrative embodiment, fragmentation analysis system 138 does not access any directory tables of storage medium 135 at any time prior to or during the fragmentation analysis.

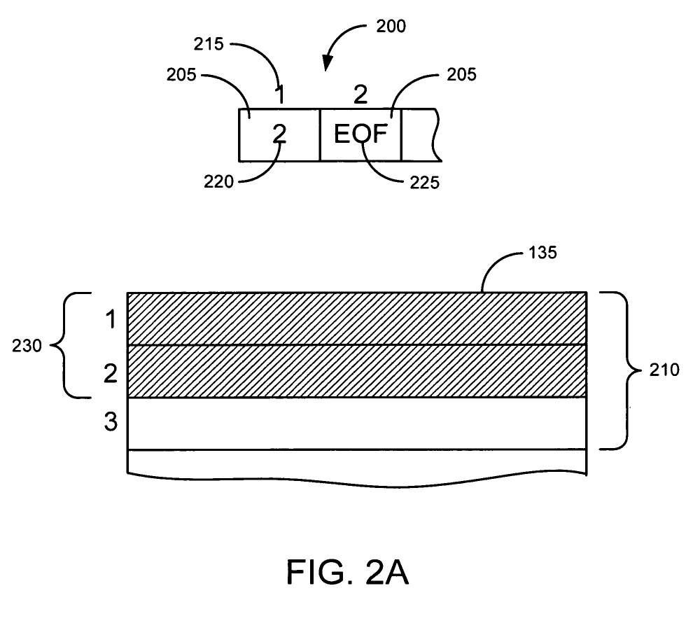

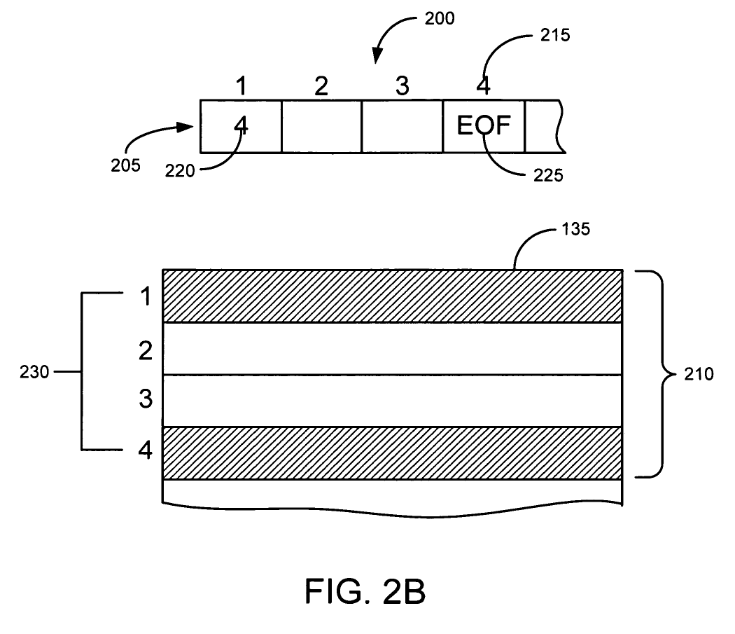

Before embodiments of the invention are described in further detail, some introductory context and terminology are first provided. FIG. 2A is a diagram of a non-fragmented file and its associated file-allocation-table (FAT) entries, in accordance with an illustrative embodiment of the invention. In FIG. 2A, a file composed of only two clusters is shown for simplicity. FAT 200 contains an entry 205 for each cluster 210 on storage medium 135. The number (or address) of the cluster 210 to which each entry 205 corresponds is indicated in FIG. 2A by a cluster number 215. In an actual FAT file system, the first available data cluster is Cluster 2. For simplicity, however, the first available data cluster is shown as Cluster 1 throughout this Detailed Description. Each entry 205 contains a value, which can be (1) an index 220 that points to the next cluster in the file or (2) a special value. Special values include, for example, end-of-file (EOF) marker 225 (typically represented as −1 through −8), an unused-cluster marker (typically represented as zero), a bad-cluster marker (typically represented as −9), and a reserved-cluster marker.

In FIG. 2A, file 230 occupies contiguous Clusters 1 and 2 on storage medium 135. Such a file 230 for which all associated clusters are contiguous on storage medium 135 is herein called a “non-fragmented file.” FAT entry 205 associated with Cluster 1 contains a “2,” an index 220 pointing to the next cluster 210 of file 230. FAT entry 205 associated with Cluster 2 contains EOF marker 225, signifying that Cluster 2 is the final cluster 210 of file 230. Generalizing, let FAT(K) be the value contained in the entry 205 associated with Cluster K. A file 230 composed of N clusters 210 and beginning at Cluster J is non-fragmented if, and only if, FAT(K)=K+1 for each cluster K, K=J, J+1, J+2, . . . , (J+N−2), and FAT(J+N−1)=EOF. That is, each FAT entry 205 associated with a non-fragmented file 230, except that associated with its last cluster 210, contains a consecutively higher-numbered index 220. The entry 205 associated with the last cluster 210 in file 230, of course, contains an EOF marker 225.

FIG. 2B is a diagram of a fragmented file and its associated FAT entries, in accordance with an illustrative embodiment of the invention. In FIG. 2B, file 230 occupies non-contiguous Clusters 1 and 4 on storage medium 135. Such a file 230 in which at least one fragmentation occurs is herein called a “fragmented file.” In FIG. 2B, FAT entry 205 associated with Cluster 1 contains a “4,” an index 220 pointing to the next cluster 210 of file 230. FAT entry 205 associated with Cluster 4 contains EOF marker 225, signifying that Cluster 4 is the final cluster 210 of file 230. The fragmentation in file 230 can be detected by reading entry 205 for Cluster 1. Since FAT(1)≠2 (the consecutively higher-numbered cluster 210), it is apparent that a fragmentation is present in file 230. Using the notation introduced above, a fragmentation occurs whenever, for a used Cluster K, FAT(K)≠K+1 and FAT(K)≠EOF (i.e., FAT(K) is any index 220 other than K+1).

An entry 205 for a particular Cluster K may satisfy FAT(K)=K+1, yet Cluster K may be part of a fragmented file 230 (i.e., one or more fragmentations may occur elsewhere in the file). In such cases, analysis module 145 may infer, as it examines FAT entries 205, that Cluster K and a set of other clusters 210 constitute a file 230, and analysis module 145 may treat all clusters 210 that make up that file 230 as “fragmented clusters” in compiling its statistics.

Illustrative embodiments of the invention will now be described in more detail. Before fragmentation analysis system 138 analyzes storage medium 135, fragmentation analysis system 138 first determines that storage medium 135 has a FAT file system (as opposed to, e.g., a New Technology File System (NTFS)). To do so, fragmentation analysis system 138 may examine the first sector of storage medium 135 (e.g., the boot sector). That first sector contains the number of logical partitions on the drive (each logical partition on a physical drive has its own FAT), the number of sectors each FAT occupies, and the type of each logical partition (e.g., FAT16 or FAT32). The number (“16” or “32”) appended to “FAT” indicates the width, in bits, of each FAT entry 205 in a particular file system. The first sector of the volume also contains the number of hidden sectors on the volume (the number of sectors from the beginning of the volume to the first data allocation). Fragmentation analysis system 138 can find any needed information to read FAT 200 into memory 130 by examining the first sector of the volume as just described, obviating the need to consult directory tables associated with storage medium 135. In an illustrative embodiment, data acquisition module 140 performs this preliminary information gathering.

Once a FAT on storage medium 135 has been identified and located, data acquisition module 140 reads FAT 200 into memory 130. In some embodiments, data acquisition module 140 reads FAT 200 into memory 130 in its entirety before analysis module 145 analyzes FAT 200. In other embodiments, data acquisition module 140 reads only a portion of FAT 200 into memory 130 initially, reading subsequent portions of FAT 200 into memory 130 as needed. One advantage of the invention over conventional fragmentation analysis techniques is that, once FAT 200 has been loaded into memory 130, the fragmentation analysis may be performed on FAT 200 in RAM without any further need to access storage medium 135 (e.g., to consult directory tables of storage medium 135).

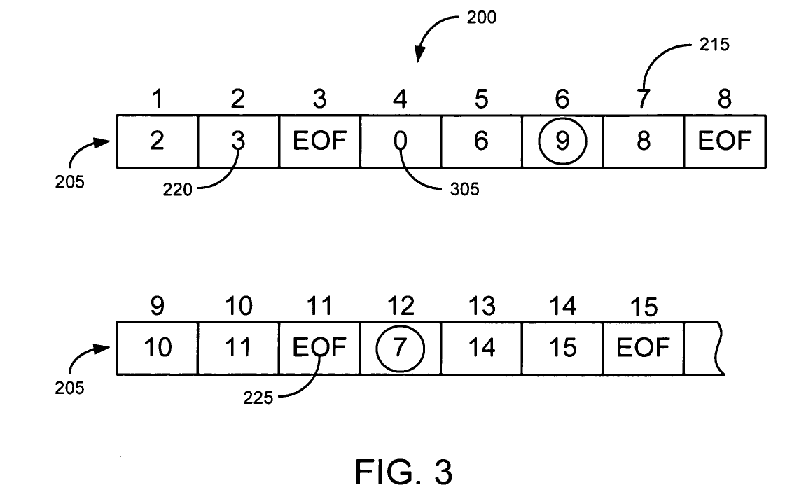

FIG. 3 is a diagram of a FAT 200 that will be used in explaining how the extent of data fragmentation on a storage medium 135 can be estimated substantially without accessing a directory table of the storage medium 135, in accordance with an illustrative embodiment of the invention. In FIG. 3, 15 entries 205 of an illustrative FAT 200 are shown. To avoid clutter, reference numerals have been omitted from some like elements. Entries 205 at which fragmentations occur are marked with circles in FIG. 3. Analysis module 145 may, in memory 130, examine the entries 205 of FAT 200 in sequential order. The entries 205 associated with Clusters 1-3 are associated with a non-fragmented file 230. As analysis module 145 examines the FAT entries 205 of Clusters 1-3 in FIG. 3, it may count those clusters 210 as non-fragmented clusters. Furthermore, analysis module 145 can easily infer that Clusters 1-3 constitute a non-fragmented file 230. When analysis module 145 encounters an EOF marker 225 in FAT 200 (e.g., entry 205 for Cluster 3), it may increment a count of files and directories (folders) on storage medium 135. The entry 205 for Cluster 4 in FIG. 3 contains an unused-cluster marker 305, signifying that Cluster 4 is free (available). Accordingly, analysis module 145 may increment a count of unused clusters 210.

Analysis module 145 may, initially at least, count Cluster 5 as non-fragmented. When analysis module 145 encounters the index 220 in the entry 205 for Cluster 6, it notes a fragmentation and may increment a count of fragmentations and/or fragmented clusters. By keeping track of how many contiguous used clusters have been encountered in FAT 200 since the last EOF marker 225 was read, analysis module 145 may also infer that Cluster 5 is part of the same fragmented file 230 as Cluster 6 and, therefore, that Cluster 5 should be included, along with Cluster 6, in a count of fragmented clusters 210. Of course, analysis module 145 may also adjust the tentative count of non-fragmented clusters 210 accordingly.

If only fragmentations are counted (see the discussion of FIG. 2B above), the estimate of the extent of data fragmentation on storage medium 135 is likely to be too optimistic. Even one fragmentation in a file 230 still renders that file “fragmented,” impacting system performance. Consequently, in an illustrative embodiment, analysis module 145 treats all clusters 210 constituting a fragmented file 230 as “fragmented.” That is, analysis module 145 includes all clusters 210 belonging to such a file 230 in a count of fragmented clusters. This allows fragmentation statistics to be counted at the cluster level rather than at the file level. In other embodiments, analysis module 145 may use file relationships among clusters 210 inferred from FAT 200 to count fragmented or non-fragmented files instead of fragmented or non-fragmented clusters.

Analysis module 145 may, initially at least, count Cluster 7 as non-fragmented. In encountering the entry 205 for Cluster 8, analysis module 145 may again increment the tally of files and folders. At the entry 205 for Cluster 9, analysis module 145 may determine that Cluster 9 is the cluster 210 to which the index 220 in the entry 205 for Cluster 6 pointed. For example, analysis module 145 may keep a running list of the “jumped-to” clusters 210 (such as Cluster 9 in this example) associated with fragmentations (such as the one occurring at Cluster 6 in this example) as it encounters the fragmentations. When the entry 205 of the jumped-to cluster 210 is later reached, analysis module 145 can take appropriate action.

When analysis module 145 reaches entry 205 for jumped-to Cluster 9, its inference of the structure of the file 230 made up of Clusters 5-6 and 9-11 may resume. Analysis module 145 can infer that a series of contiguous clusters 210 commencing with Cluster 9 and ending with Cluster 11, whose entry 205 contains an EOF marker 225, are part of the same file 230 as Clusters 5 and 6. Therefore, analysis module 145 can include Clusters 9-11 in a count of fragmented clusters 210 and adjust its tentative count of non-fragmented clusters 210 accordingly.

Analysis module 145 identifies another fragmentation at the entry 205 for Cluster 12, whose index 220 points backward to Cluster 7. Optionally, analysis module 145 may trace this index 220 back to Cluster 7 to infer that Clusters 7 and 8 belong to the same file 230 as Cluster 12 and update its statistics accordingly. Doing so improves the accuracy of the fragmentation estimate but is not essential in every embodiment of the invention.

In examining the entries 205 for Clusters 13-15, analysis module 145 encounters no further fragmentations and updates its statistics (e.g., a count of non-fragmented clusters 210 and a count of files and directories) accordingly.

As analysis module 145 examines each FAT entry, it may also update a count of “used” clusters 210 on storage medium 135.

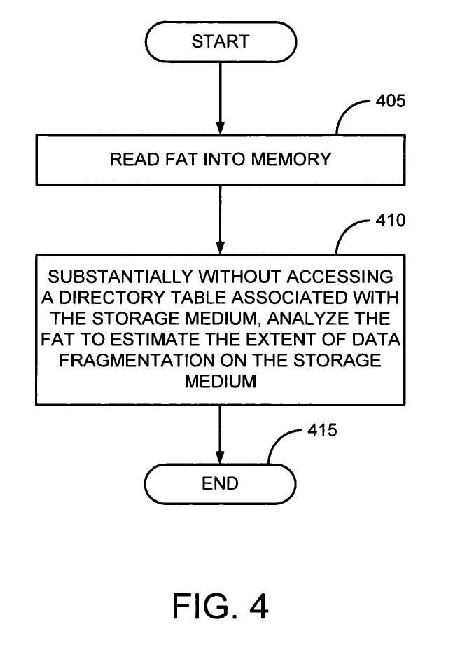

FIG. 4 is a flowchart of a method for estimating the extent of data fragmentation on a storage medium 135, in accordance with an illustrative embodiment of the invention. At 405, data acquisition module 140 reads FAT 200 into memory 130. At 410, analysis module 145, substantially without accessing a directory table associated with storage medium 135, analyzes FAT 200 as explained above to estimate the extent of data fragmentation on storage medium 135. At 415, the process terminates.

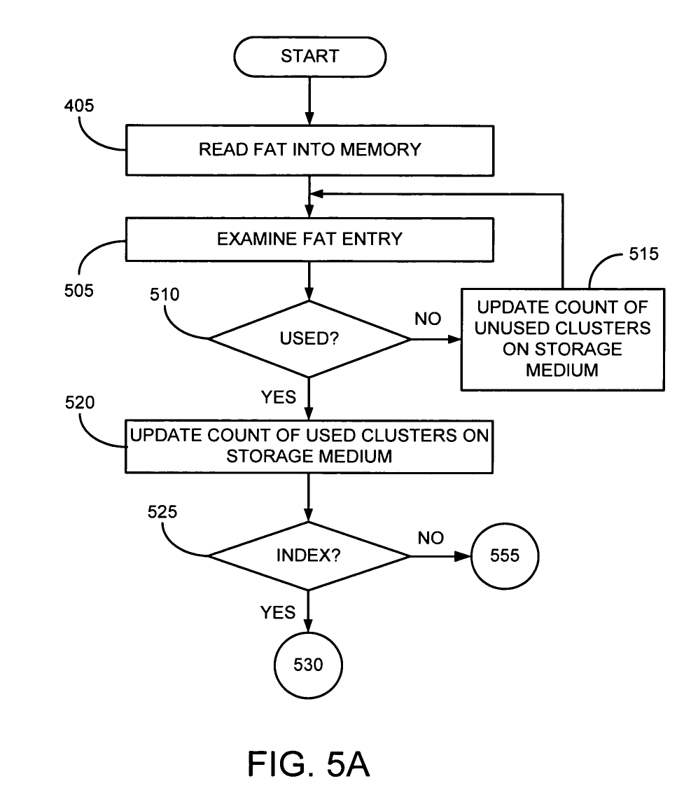

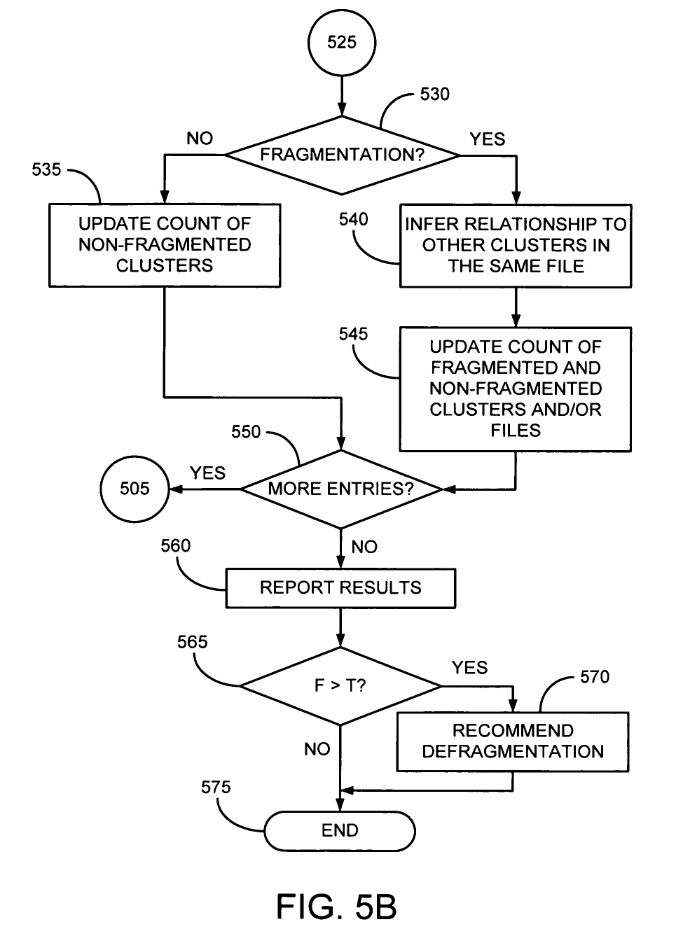

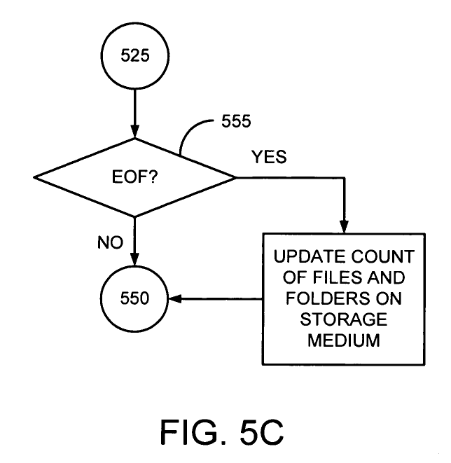

FIGS. 5A-5C are a flowchart of a method for estimating the extent of data fragmentation on a storage medium 135, in accordance with another illustrative embodiment of the invention. First, step 405 is performed as in FIG. 4. At 505, analysis module 145 examines an entry 205 of FAT 200. In this illustrative embodiment, analysis module 145 begins with the first entry 205 and proceeds sequentially to the last entry 205. At 510, analysis module 145 determines whether the cluster 210 associated with the entry 205 read at 505 is used or not. If not, analysis module 145 updates its count of unused clusters 210 at 515, and the process returns to 505. Otherwise, analysis module 145 updates its count of used clusters 210 at 520. At 525, analysis module 145 determines whether the value contained in the entry 205 read at 505 is an index 220. If so, the process proceeds to step 530 in FIG. 5B. Otherwise, the process proceeds to step 555 in FIG. 5C.

At 530 in FIG. 5B, analysis module 145 determines whether the entry 205 read at 505 indicates a fragmentation. If not, analysis module 145 updates, tentatively at least, its count of non-fragmented clusters 210 at 535, and the process proceeds to 550. If so, analysis module 145 infers, at 540, to the extent possible at the time, that other clusters 210 are part of the same file 230 as the cluster 210 at whose entry 205 the fragmentation occurred. As explained above, part of this inference may be postponed until analysis module 145 reaches the entry 205 for the jumped-to cluster 210 associated with the fragmentation. At 545, analysis module 145 updates a count of fragmented and non-fragmented clusters 210 (and, optionally, a count of fragmented files) in accordance with the information about file structure inferred at 540.

If more entries 205 remain to be read at 550, the process returns to step 505 in FIG. 5A. Otherwise, report generation module 150 reports the results of the fragmentation analysis (e.g., an estimate of the extent of data fragmentation on storage medium 135) at 560. If the estimated extent of data fragmentation (F) exceeds a predetermined threshold (T) at 565, fragmentation analysis system 138 recommends, at 570, that storage medium 135 be defragmented. In one illustrative embodiment, F is the percentage of used clusters 210 on storage medium 135 that are considered “fragmented”(i.e., associated with fragmented files), and T is about 20 percent. At 575, the process terminates.

If, at 525, analysis module 145 determines that the value contained in the entry 205 read at 505 is not an index 220, analysis module 145 determines, at 555, whether the value is an EOF marker 225. If not, the process proceeds to 550. Otherwise, analysis module 145 updates a count of files and folders on storage medium 135, and the process then proceeds to 550.

In conclusion, the present invention provides, among other things, a method and system for rapid data-fragmentation analysis of a FAT file system. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. For example, it is not required that all of the various statistics mentioned above be collected in every embodiment of the invention. In some embodiments, some subset of those statistics or even other statistics not mentioned herein that, nevertheless, can be derived from examining a FAT 200 may be collected in analyzing a storage medium 135 for fragmentation.

What is claimed is:

1. A method, comprising:
reading into a memory of a computer a file allocation table (FAT) associated with a storage medium of the computer, the storage medium having a plurality of clusters, each cluster having an associated entry in the FAT; and
analyzing, substantially without accessing a directory table associated with the storage medium, the FAT to estimate the extent of data fragmentation on the storage medium.

2. The method of claim 1, further comprising:
reporting to a user the estimated extent of data fragmentation on the storage medium; and
recommending to the user that the storage medium be defragmented, when the estimated extent of data fragmentation exceeds a predetermined threshold.

3. The method of claim 1, wherein analyzing includes counting an entry in the FAT that contains, relative to a cluster associated with that entry, an index associated with a cluster other than a consecutively higher-numbered cluster.

4. The method of claim 1, wherein analyzing includes counting an entry in the FAT that contains one of an index associated with a consecutively higher-numbered cluster relative to a cluster associated with that entry and an end-of-file marker.

5. The method of claim 1, wherein analyzing includes counting at least one of used and unused clusters on the storage medium.

6. The method of claim 1, wherein analyzing includes counting the number of files and directories on the storage medium by counting end-of-file markers contained in entries of the FAT.

7. The method of claim 1, wherein analyzing includes:
inferring, as entries of the FAT are examined, that a set of clusters on the storage medium constitutes a file; and
treating all clusters in the set of clusters as fragmented, when there is at least one fragmentation among the clusters in the set of clusters.

8. The method of claim 1, wherein the FAT is read into the memory in its entirety before it is analyzed.

9. A system, comprising:
a data acquisition module configured to read into a memory of a computer a file allocation table (FAT) associated with a storage medium of the computer, the storage medium having a plurality of clusters, each cluster having an associated entry in the FAT; and
an analysis module configured to analyze, substantially without accessing a directory table associated with the storage medium, the FAT to estimate the extent of data fragmentation on the storage medium.

10. The system of claim 9, wherein the analysis module is configured to count an entry in the FAT that contains, relative to a cluster associated with that entry, an index associated with a cluster other than a consecutively higher-numbered cluster.

11. The system of claim 9, wherein the analysis module is configured to count an entry in the FAT that contains one of an index associated with a consecutively higher-numbered cluster relative to a cluster associated with that entry and an end-of-file marker.

12. The system of claim 9, wherein the analysis module is configured to:
infer, as it examines entries of the FAT, that a set of clusters on the storage medium constitutes a file; and
treat all clusters in the set of clusters as fragmented, when there is at least one fragmentation among the clusters in the set of clusters.

13. A system, comprising:
means for reading into a memory of a computer a file allocation table (FAT) associated with a storage medium of the computer; and
means for analyzing, substantially without accessing a directory table associated with the storage medium, the FAT to estimate the extent of data fragmentation on the storage medium.

14. A computer-readable storage medium containing program instructions, comprising:
a first instruction segment configured to read into a memory of a computer a file allocation table (FAT) associated with a storage medium of the computer, the storage medium having a plurality of clusters, each cluster having an associated entry in the FAT; and
a second instruction segment configured to analyze, substantially without accessing a directory table associated with the storage medium, the FAT to estimate the extent of data fragmentation on the storage medium.

15. The computer-readable storage medium of claim 14, further comprising:
a third instruction segment configured to:
report to a user the estimated extent of data fragmentation on the storage medium; and
recommend to the user that the storage medium be defragmented, when the estimated extent of data fragmentation exceeds a predetermined threshold.

16. The computer-readable storage medium of claim 14, wherein the second instruction segment is configured to count an entry in the FAT that contains, relative to a cluster associated with that entry, an index associated with a cluster other than a consecutively higher-numbered cluster.

17. The computer-readable storage medium of claim 14, wherein the second instruction segment is configured to count an entry in the FAT that contains one of an index associated with a consecutively higher-numbered cluster relative to a cluster associated with that entry and an end-of-file marker.

18. The computer-readable storage medium of claim 14, wherein the second instruction segment is configured to count at least one of used and unused clusters on the storage medium.

19. The computer-readable storage medium of claim 14, wherein the second instruction segment is configured to count the number of files and directories on the storage medium by counting end-of-file markers contained in entries of the FAT.

20. The computer-readable storage medium of claim 14, wherein the second instruction segment is configured to:
infer, as it examines entries of the FAT, that a set of clusters on the storage medium constitutes a file; and
treat all clusters in the set of clusters as fragmented, when there is at least one fragmentation among the clusters in the set of clusters.

21. The computer-readable storage medium of claim 14, wherein the first instruction segment is configured to read the FAT into the memory in its entirety before it is analyzed by the second instruction segment.
